(19) United States
(12) Patent Application Publication
(10) Pub. No.: US 2012/0099535 A1
(43) Pub. Date: Apr. 26, 2012

(54) METHOD AND APPARATUS FOR TRANSMISSION FAILURE DETECTION IN TIME DIVISION SYNCHRONOUS CODE DIVISION MULTIPLE ACCESS (TD-SCDMA) NETWORKS

(76) Inventors: Tom Chin, San Diego, CA (US); Guangming Shi, San Diego, CA (US); Kuo-Chun Lee, San Diego, CA (US)

(21) Appl. No.: 13/379,737

(22) PCT Filed: Mar. 26, 2010
(86) PCT No.: PCT/US10/28973

§ 371 Date: Dec. 21, 2011

Related U.S. Application Data
(60) Provisional application No. 61/251,622, filed on Oct. 14, 2009.

(51) Int. Cl. H04W 4/00

(52) U.S. Cl. 370/328

(57) ABSTRACT

A method, an apparatus, and a computer program product for wireless communication are provided, wherein a first synchronization signal is transmitted to request access to a Node B; an acknowledgement transmitted from the Node B is detected, wherein the acknowledgment comprises an indication that a second synchronization signal was transmitted after the first synchronization signal; and the first synchronization signal is retransmitted based on the acknowledgment.

### CROSS-REFERENCE TO RELATED APPLICATIONS

This application claims the benefit of U.S. Provisional Patent Application No. 61/251,622, entitled “METHOD AND APPARATUS FOR TRANSMISSION FAILURE DETECTION IN TD-SCMA NETWORKS,” filed on Oct. 14, 2009, which is expressly incorporated by reference herein in its entirety.

### BACKGROUND

I. Field

Aspects of the present disclosure relate generally to wireless communication systems, and more particularly, to a method and apparatus for transmission failure detection in time division synchronous code division multiple access (TD-SCDMA) networks.

II. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

The China Communications Standard Association (CCSA) has published a series of TDD-based 3G standards for TD-SCDMA systems. In TD-SCDMA systems, the user equipment (UE) needs to perform a random access procedure as the first procedure to contact the network for an uplink (UL) operation. The UL random access procedure is defined in the CCSA standards YD/T 1371.5-2008 Technical requirements for Uu Interface of 2 GHz TD-SCDMA Digital Cellular Mobile Communication Network Physical Layer Technical Specification Part 5: Physical Layer Procedure. Often, the UE needs to determine if a request to access the network has been received or detect whether a transmission failure has occurred.

It would be preferable to provide additional robustness to current random access procedures.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a block diagram conceptually illustrating an example of a processing system of the UE of FIG. 3.

FIG. 5 illustrates a flow diagram of the operation of the communication system using a random access procedure.

FIG. 6 illustrates a timing diagram of the operation of the communication system using an existing random access procedure.

FIG. 7 illustrates a flow diagram of the operation of the communication system using a random access procedure configured in accordance with one aspect of the disclosure.

FIG. 8 illustrates a timing diagram of the operation of the communication system using the random access procedure of FIG. 7.

FIG. 9 is a conceptual block diagram illustrating the functionality of an exemplary UE apparatus for transmission failure detection in accordance with one aspect of the disclosure.

### DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

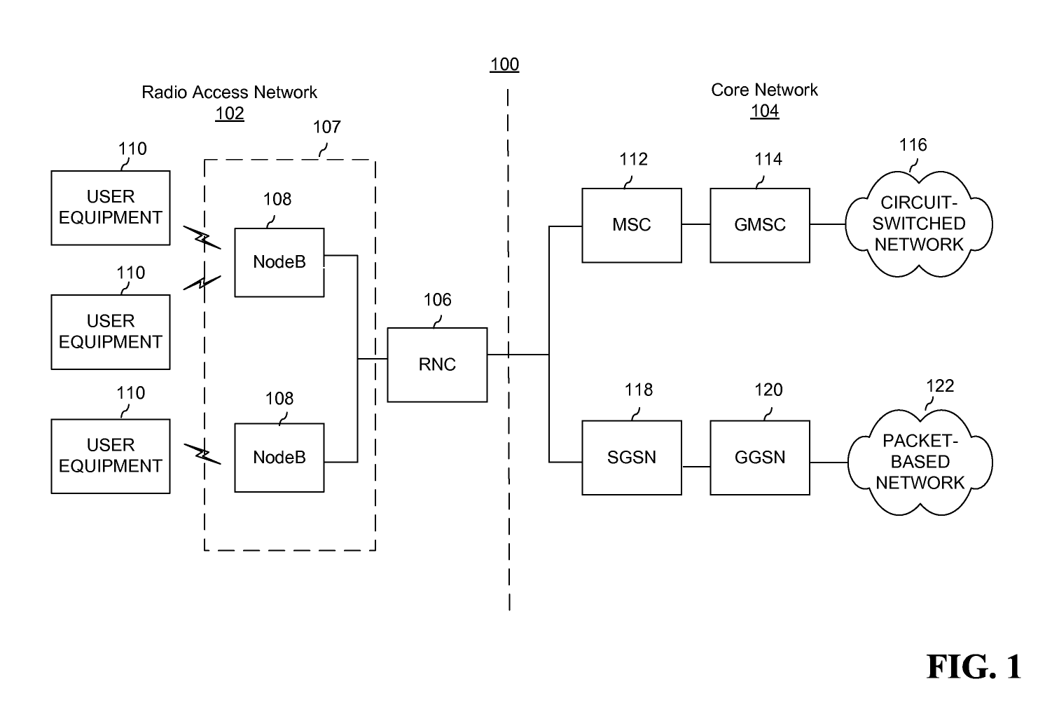

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

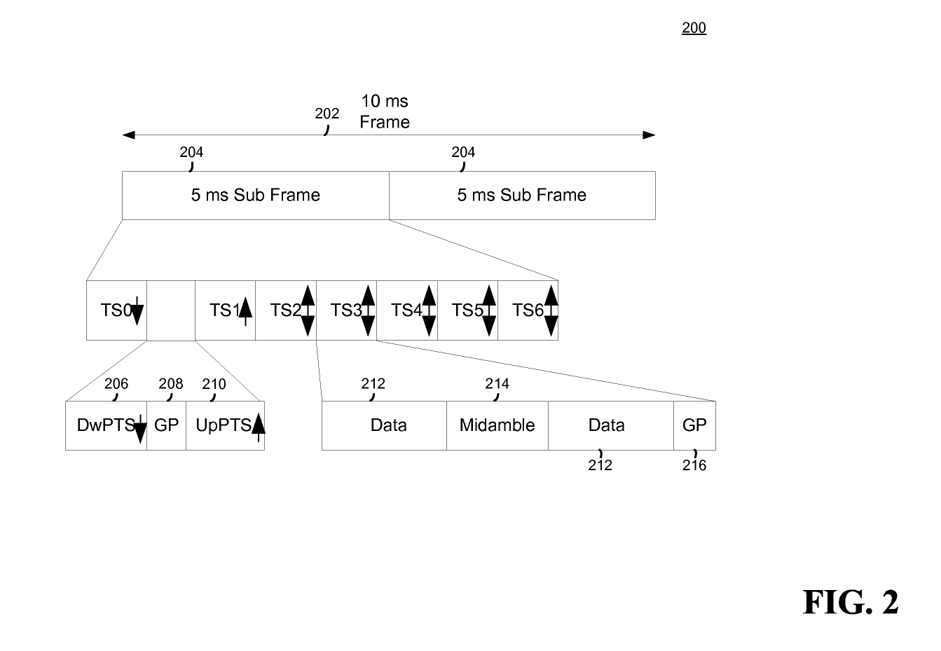

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

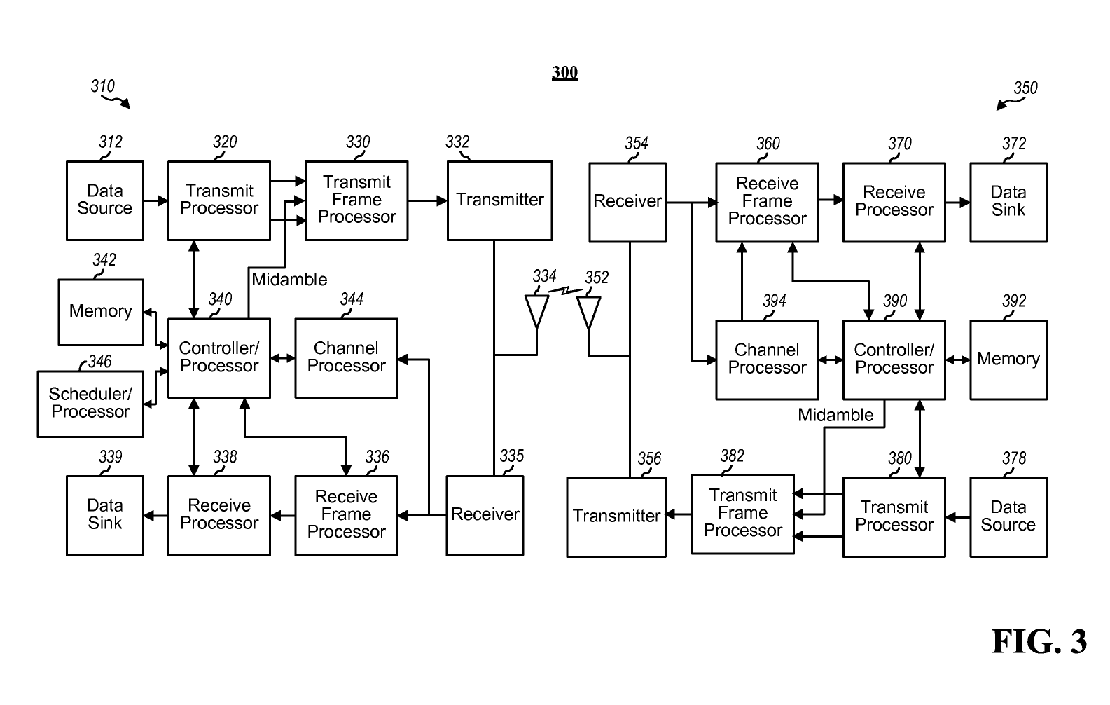

FIG. 3 is a block diagram of a Node B 310 in communication with a UE 350 in a RAN 300, where the RAN 300 may be the RAN 202 in FIG. 2, the Node B 310 may be the Node B 208 in FIG. 2, and the UE 350 may be the UE 210 in FIG. 2. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through one or more antennas 334. The one or more antennas 334 may be implemented with beam steering bidirectional adaptive antenna arrays or other similar beam technologies.

At the UE 350, a receiver 354 receives the downlink transmission through one or more antennas 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the one or more antennas 352.

The uplink transmission is processed at the Node B 310 in a manner similar to that described in connection with the receiver function at the UE 350. A receiver 335 receives the uplink transmission through the one or more antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

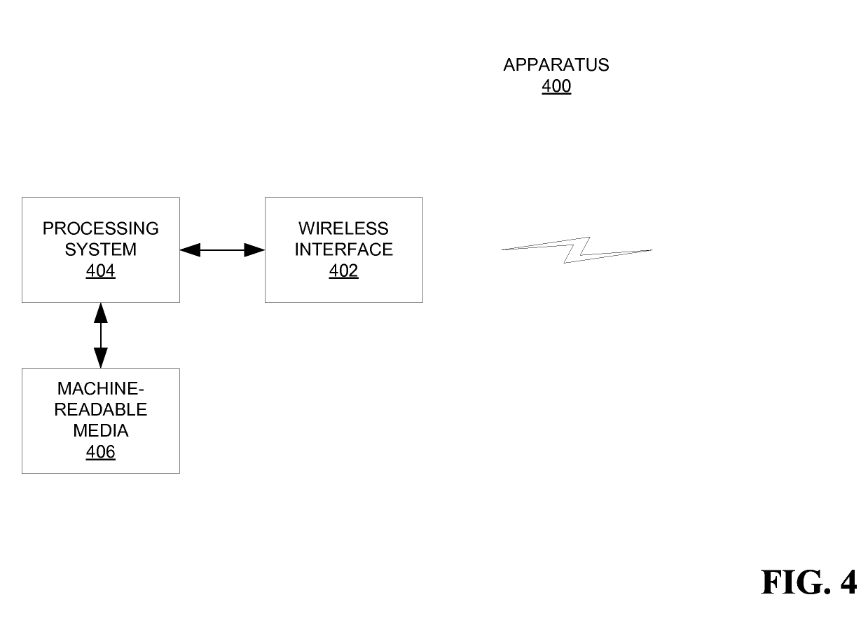

FIG. 4 is a block diagram illustrating a configuration for an apparatus 400, which can be a UE 110. The apparatus 400 may include a wireless interface 402, a processing system 404, and machine-readable media 406. The wireless interface 402 may be integrated into the processing system 404 or distributed across multiple entities in the apparatus. The processing system 404 may be implemented with one or more processors. The one or more processors may be implemented with any combination of general-purpose microprocessors, microcontrollers, digital signal processors (DSPs), digital signal processing devices (DSPDs), field programmable gate array (FPGAs), programmable logic devices (PLDs), controllers, integrated circuits (ICs), application specific ICs (ASICs), state machines, gated logic, discrete hardware components, or any other suitable entities that can perform calculations or other manipulations of information.

The processing system 404 is coupled to machine-readable media 406 for storing software. Alternatively, the processing system 404 may itself include the machine-readable media 406. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 404 to perform the various functions described below, as well as various protocol processing functions.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, and/or data can be passed, forwarded, or transmitted using any suitable means including memory sharing, message passing, token passing, and network transmission.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

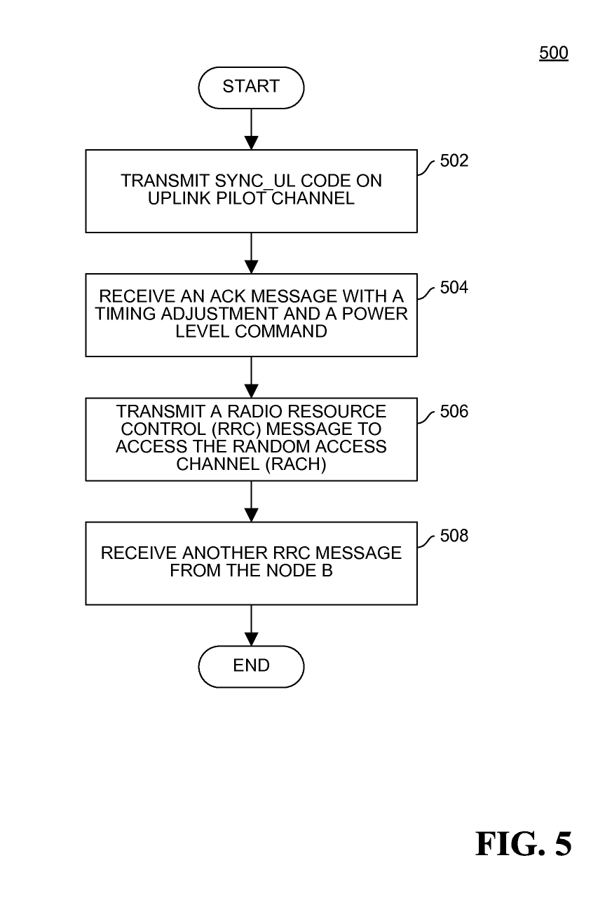

In TD-SCDMA network configured in accordance with an aspect of the disclosure, a UE needs to perform a random access procedure for a Node B in order to contact the network for an uplink (UL) operation. The UL random access procedure is defined in the CCSA standards YD/T 1371.5-2008 Technical requirements for Uu Interface of 2 GHz TD-SCDMA Digital Cellular Mobile Communication Network Physical Layer Technical Specification Part 5: Physical Layer Procedure. FIG. 5 illustrates a generalized description of a random access procedure 500 in accordance with the standard.

In step 502, the UE will send a randomly selected code, referred to as a SYNC_UL code, on the Uplink Pilot Channel (UpPCH) to the Node B. In one aspect of the disclosure, a maximum of 8 codes may be available.

In step 504, the UE receives a timing adjustment and a power level command that may be used to send a Random Access Channel (RACH) message on the Fast Physical Access Channel (FPACH) from the Node B, after the Node B has received the SYNC_UL code from step 502. In one aspect of the disclosure, a message may be formed with one or more frames.

In step 506, if the UE detects a match of the transmission parameters, such as the subframe index and SYNC_UL code, then the UE may transmit a Radio Resource Control (RRC) message on the corresponding Physical Random Access Channel (PRACH) to the Node B.

In step 508, the UE receives another RRC message from the Node B after the Node B receives the RRC sent by the UE in step 506.

TD-SCDMA systems may have a few different configurations when one FPACH is configured, where:
The Random Access Channel (RACH) Transmission Time Interval (TTI), denoted by L, subframes may be equal to 1 (i.e. 5 ms), 2 (i.e. 10 ms), or 4 (i.e. 20 ms).
One FPACH may correspond to N PRACHs, where N≦L.
The Node B transmits the acknowledgement on FPACH on a subframe number SFN′ mod L=0, 1, . . . , N−1.
The UE may only wait for acknowledgement for at most WT subframes on FPACH following SYNC_UL code transmission, where WT is a configured parameter in the System Information message: WT=1, 2, 3, 4.
If UE receives FPACH on subframe number mod L=n, then it uses PRACH n to transmit to avoid collision on PRACH.
Transmission of RACH starts two subframes following FPACH reception. But if FPACH is received on an odd subframe number and L>1, then three subframes are needed. This may impose constrains on the operation of the system, especially when the UE may only listen to the acknowledgement for at most 4 subframes following a SYNC_UL code transmission.

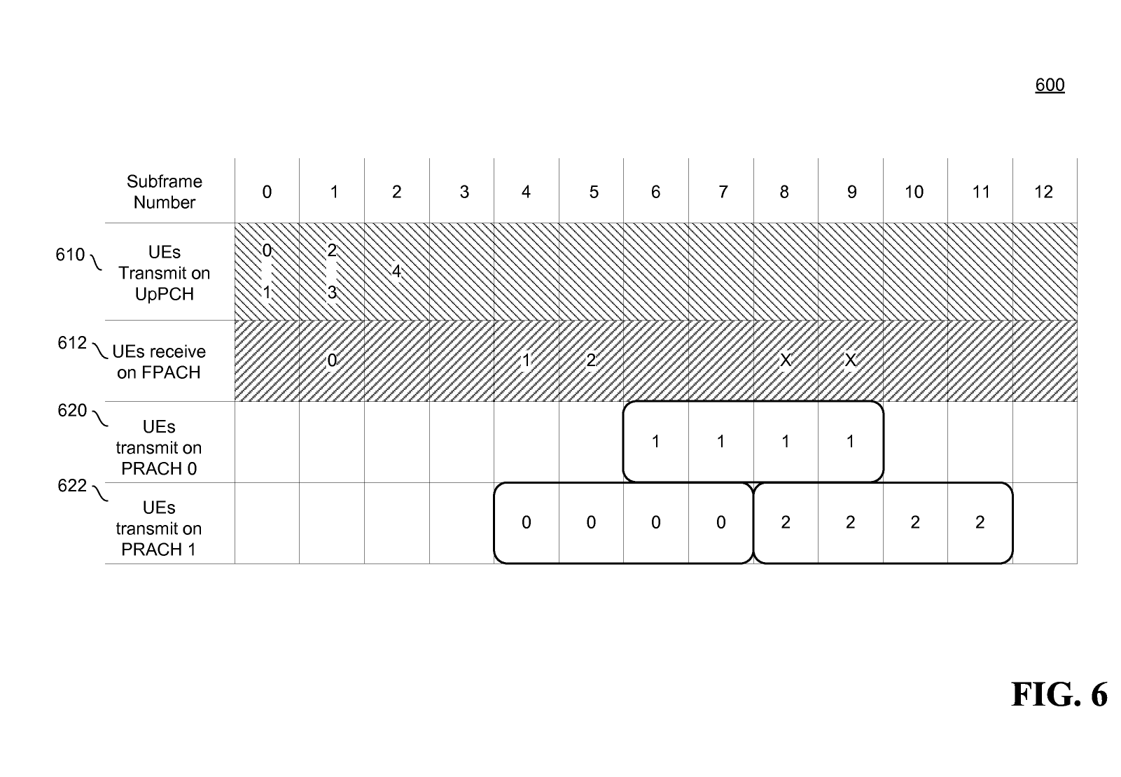

As illustrated by a timing diagram 600 in FIG. 6, where one or more UEs may not receive an acknowledgement message in time because of certain constraints imposed by the current approach to random access procedures. In the diagram, it is assumed that the TTI is 4 subframes (i.e., L=4), and the maximum number of subframes that each UE may wait for an ACK on an FPACH 612 is 4 subframes (i.e., WT=4). Further, there are two PRACHs 620, 622 for the FPACH 612 (i.e., N=2). As illustrated, five (5) UEs 0 to 4 transmit the SYNC_UL codes in the first 3 subframes 0 to 3 on a UpPCH 610, and it is assumed that the Node B has successfully decoded all SYNC_UL codes. Since there are only two PRACHs available and TTI=4 subframes, the node B may only transmit FPACH ACK on the first two subframes of each 4 subframe interval. For example, the node B may transmit FPACH ACK on subframes 0, 1, 4, 5, 8 and 9, but subframe 0 is not allowed assuming that the node B will take some time to reply. Thus, UEs 3 and 4 may not receive an ACK on the FPACH because WT=4 and unless there is an increase in WT, an ACK will not be sent.

However, there are some advantages for small WT. For example, there is a smaller overhead in sending FPACH ACK messages. Further, as a UE will retransmit the SYNC_UL code if the node B does not detect a SYNC_UL code due to loading or interference and, therefore, the UE will not wait long before retransmission.

The TD-SCDMA standards provides an FPACH ACK message with the following format:

| Field | Length | Description |
|---|---|---|
| Signature Reference Number | 3 | Indicates the received |
| | (MSB) | SYNC_UL code from |
| | | the UE |
| Relative Sub-Frame Number | 2 | Sub-Frame number |
| | | preceding the ACK |
| Received starting position of the | 11 | Used for timing |
| UpPCH (UpPCHPOS) | | correction |
| Transmit Power Level Command | 7 | Used for power level |
| for RACH message | | command for sending |
| | | RACH message |
| Reserved bits | 9 | N/A |
| | (LSB) | |

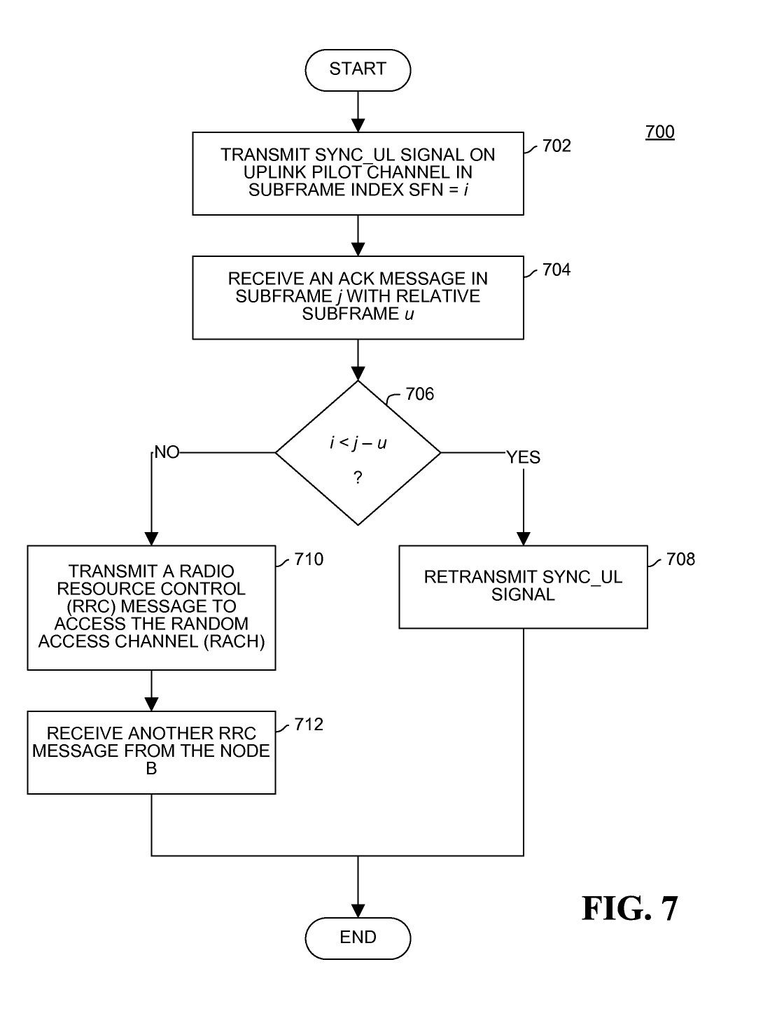

FIG. 7 illustrates a random access process 700 configured in accordance with one aspect of the disclosure to address issues related to waiting for an ACK. In one aspect of the disclosure, the system is configured to support an increased size of the WT parameter through the use of reserved bits. The increased size of the WT will be used to represent the relative subframe number. To support backward compatibility, several bits in the reserved field are allocated to indicate the MSB bits of the relative subframe number. The proposed FPACK ACK message is shown in the following table. The k additional bits may be a generalized format. However, if k additional bits are allocated, then WT may be increased up to a value of 2^{k+2}−1. An example of an FPACH ACK message configured in accordance with one aspect of the disclosure is disclosed as follows:

| Field | Length | Description |
|---|---|---|
| Signature Reference Number | 3 (MSB) | SYNC_UL Code |
| Relative Sub-Frame Number | 2 | LSB 2 bits in Sub-Frame |
| (LSB 2 bits) | | number preceding the |
| | | ACK |
| Received starting position of the | 11 | Used for timing |
| UpPCH (UpPCHPOS) | | correction |
| Transmit Power Level Command | 7 | Used for power level |
| for RACH message | | command for sending |
| | | RACH |
| Relative Sub-Frame Number | k | MSB k bits in Sub- |
| (LSB k bits) | | Frame number |
| | | preceding the ACK |
| Reserved bits | 9-k (LSB) | N/A |

The disclosed system proposes a solution to the limitation of waiting for the ACK in the random access procedure. In one aspect of the disclosure, the value of WT may be determined using the following formula:

WT=M*L*L/N

where, M is the number of SYNC_UL codes that the node B may simultaneously detect on UpPCH; N is the number of PRACHs; and L is the number of TTI. The following example describes an improved case with WT=8.

In order to avoid the UE having to wait for an ACK message in case the network does not receive a SYNC_UL code due to bad channel or high load, this disclosure proposes a first-receive-first-ACK rule in which the node B may ACK the detected SYNC_UL codes in sequence. That is, an ACK of the SYNC_UL code received in a later subframe number may be sent after all ACK's of SYNC_UL codes received in earlier subframe number.

Referring back to FIG. 7, in step 702, the UE will transmit a SYNC_UL code on the uplink pilot channel. Suppose the UE transmits this SYNC_UL signal in subframe index SFN′=i, and monitors a received ACK in SFN′=j on FPACH with relative subframe number u in step 704.

In step 706, the UE will determine if:

i<j−u (1).

If so, then the UE detects that the Node B started to acknowledge the later subframe transmission, having skipped over the UE's SYNC_UL, and the UE may start the retransmission procedure in step 708. Since the subframe number is limited, for example, to a number only as large as 8191 (i.e., 2*4096−1), in a wrap-around case, if i>j, then j=j+8192 in the above equation (1) is included.

If the UE detects that the Node B acknowledged the SYNC_UL transmission by the UE in step 708, then operation continues with step 710, where the UE transmits an RRC message to access the RACH using the timing and power parameters contained in the FPACH ACK message.

In step 712, the UE receives another RRC message from the Node B so that the UE may continue to commence transmission to the Node B.

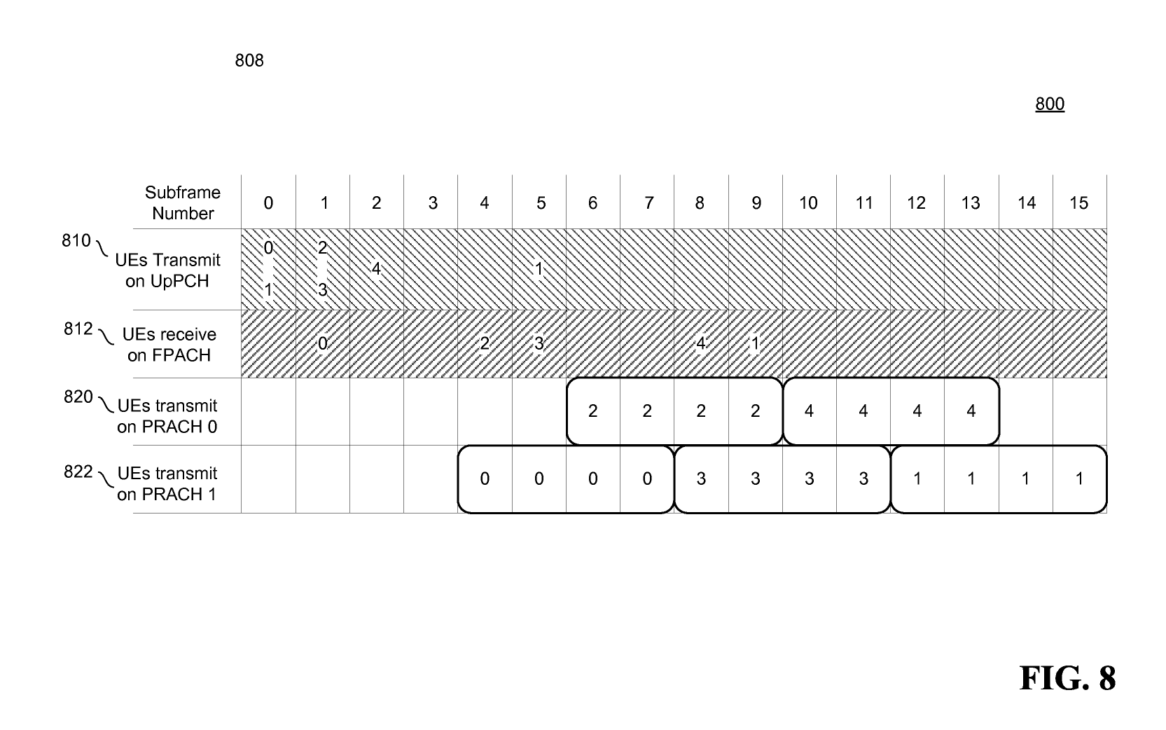

FIG. 8 is a timing diagram 800 that illustrates the operation of the system configured in accordance with one aspect of the disclosure, where five (5) UEs transmit on an UpPCH 810 and a Node B can transmit on an FPACH 812. Two PRACH 0, 1 820, 822, respectively, may be used by the UEs. The timing diagram 800 illustrates a faster UE retransmission action with a larger WT value. Assume that, in subframe 0, the Node B may not detect a transmission by UE 1. But UE 1 may detect in subframe 4 that a Node B begins to acknowledge the SYNC_UL code sent in subframe 1, i.e., which is relative subframe=3, and the determination that i (i.e., 0)<j−u (i.e., 4−3=1) becomes true. Therefore, UE 1 may immediately retransmit the SYNC_UL code in the next subframe, subframe 5. Then, UE 1 may receive an ACK in subframe 9 and transmit on PRACH 0. Note that the proposed approach in (1) may also apply to WT≦4 in the current standards to speed up the detection of failure in sending an SYNC_UL code.

The proposed enhancement may avoid waiting for ACK for an unnecessarily long time by fast detection of failure in transmission UpPCH. It may also avoid unnecessary retransmission on the UpPCH channel by increasing the waiting time for ACK.

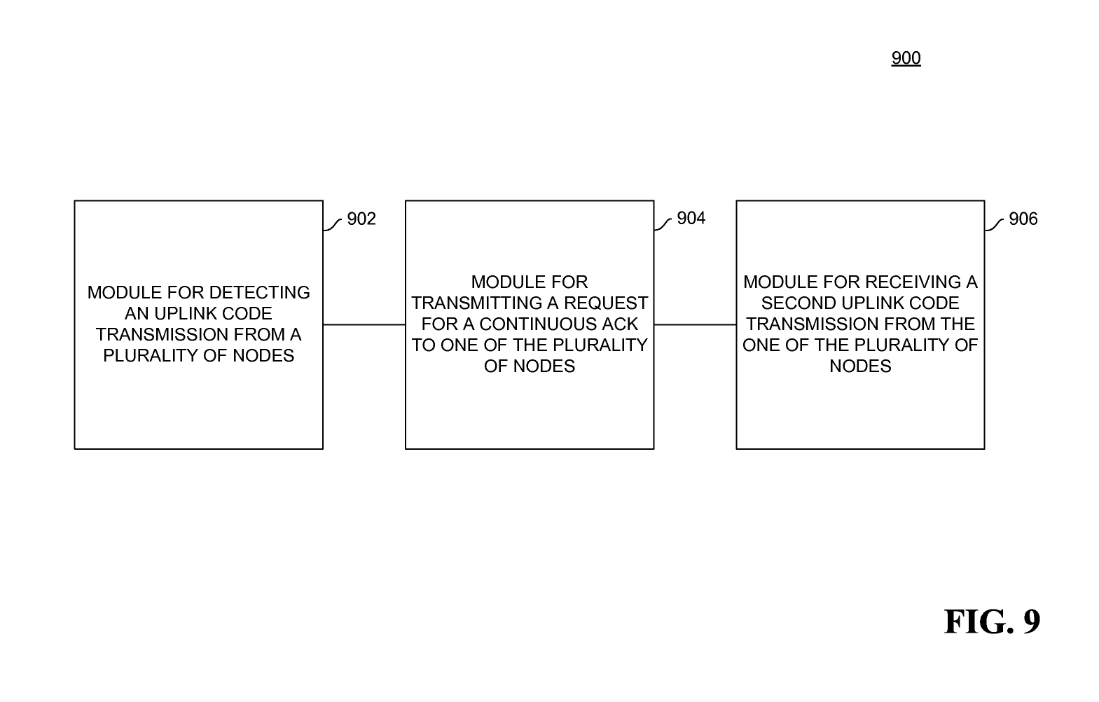

FIG. 9 is a functional block diagram 900 illustrating example blocks executed in conducting wireless communication according to one aspect of the present disclosure. In block 902, transmitting a first synchronization signal to request access to a Node B. In addition, block 904, detecting an acknowledgement transmitted from the Node B, wherein the acknowledgment comprises an indication that a second synchronization signal was transmitted after the first synchronization signal. Then, block 906, retransmitting the first synchronization signal based on the acknowledgment.

In one configuration, the apparatus 350 for wireless communication includes means for transmitting a first synchronization signal to request access to a Node B; and means for detecting an acknowledgement transmitted from the Node B, wherein the acknowledgment comprises an indication that a second synchronization signal was transmitted after the first synchronization signal. In one aspect, the aforementioned means may be the processor 390 configured to perform the functions recited by the aforementioned means. In another aspect, the aforementioned means may be a module or any apparatus configured to perform the functions recited by the aforementioned means.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a time division-synchronous code division multiple access (TD-SCDMA) system, comprising:
transmitting a first synchronization signal to request access to a Node B;
detecting an acknowledgement transmitted from the NB, wherein the acknowledgment comprises an indication that a second synchronization signal was transmitted after the first synchronization signal; and
retransmitting the first synchronization signal based on the acknowledgment.

2. The method of claim 1, wherein the acknowledgment includes a predetermined number of bits.

3. The method of claim 1, wherein the acknowledgment from the Node B is based on an order of receipt of transmission of the synchronization signal by the Node B.

4. The method of claim 1, wherein the synchronization signal comprises a SYNC_UL signal.

5. The method of claim 1, wherein the detection of the acknowledgement comprises detecting the acknowledgment for a period of time based on a predetermined parameter.

6. The method of claim 5, wherein the predetermined parameter is a programmed mobile parameter.

7. The method of claim 5, wherein the predetermined parameter is based on a number of synchronization signals that a wireless node may simultaneously detect on a pilot channel.

8. The method of claim 7, wherein the pilot channel is an uplink pilot channel (UpPCH).

9. The method of claim 5, wherein the predetermined parameter is based on a number of uplink channels.

10. The method of claim 9, wherein the uplink channel comprises a Physical Random Access Channel (PRACH).

11. The method of claim 5, wherein the predetermined parameter is based on a transmission time interval (TTI).

12. The method of claim 1, further comprising transmitting a second synchronization signal.

13. The method of claim 12, wherein the second synchronization signal is a retransmission of the synchronization signal.

14. The method of claim 1, further comprising:
detecting a transmission of a separate acknowledgment to another synchronization signal transmitted by another wireless node; and
transmitting a second synchronization signal upon determining that the other synchronization signal was transmitted after the transmission of the synchronization signal.

15. The method of claim 1, wherein the acknowledgement comprises a reference to a synchronization signal position, the reference comprising a first portion indicating a timing reference and a second portion extending the timing reference.

16. An apparatus for wireless communication in a time division-synchronous code division multiple access (TD-SCDMA) system, comprising:
means for transmitting a first synchronization signal to request access to a Node B;
means for detecting an acknowledgement transmitted from the Node B, wherein the acknowledgment comprises an indication that a second synchronization signal was transmitted after the first synchronization signal; and
means for retransmitting the first synchronization signal based on the acknowledgment.

17. The apparatus of claim 16, wherein the acknowledgment includes a predetermined number of bits.

18. The apparatus of claim 16, wherein the acknowledgment from the Node B is based on an order of receipt of transmission of the synchronization signal by the Node B.

19. The apparatus of claim 16, wherein the synchronization signal comprises a SYNC_UL signal.

20. The apparatus of claim 16, wherein the detection means comprises means for detecting the acknowledgment for a period of time based on a predetermined parameter.

21. The apparatus of claim 20, wherein the predetermined parameter is a programmed mobile parameter.

22. The apparatus of claim 20, wherein the predetermined parameter is based on a number of synchronization signals that a wireless node may simultaneously detect on a pilot channel.

23. The apparatus of claim 22, wherein the pilot channel is an uplink pilot channel (UpPCH).

24. The apparatus of claim 20, wherein the predetermined parameter is based on a number of uplink channels.

25. The apparatus of claim 24, wherein the uplink channel comprises a Physical Random Access Channel (PRACH).

26. The apparatus of claim 20, wherein the predetermined parameter is based on a transmission time interval (TTI).

27. The apparatus of claim 20, further comprising means for transmitting a second synchronization signal.

28. The apparatus of claim 27, wherein the second synchronization signal is a retransmission of the synchronization signal.

29. The apparatus of claim 16, further comprising:
means for detecting a transmission of a separate acknowledgment to another synchronization signal transmitted by another wireless node; and
means for transmitting a second synchronization signal upon determining that the other synchronization signal was transmitted after the transmission of the synchronization signal.

30. The apparatus of claim 16, wherein the acknowledgement comprises a reference to a synchronization signal position, the reference comprising a first portion indicating a timing reference and a second portion extending the timing reference.

31. A computer program product, comprising:
a computer-readable medium comprising code for:
transmitting a first synchronization signal to request access to a Node B;
detecting an acknowledgement transmitted from the Node B, wherein the acknowledgment comprises an indication that a second synchronization signal was transmitted after the first synchronization signal; and
retransmitting the first synchronization signal based on the acknowledgment.

32. The computer program product of claim 31, wherein the acknowledgment includes a predetermined number of bits.

33. The computer program product of claim 31, wherein the acknowledgment from the Node B is based on an order of receipt of transmission of the synchronization signal by the Node B.

34. The computer program product of claim 31, wherein the synchronization signal comprises a SYNC_UL signal.

35. The computer program product of claim 31, wherein the computer-readable medium further comprises code for comprises detecting the acknowledgment for a period of time based on a predetermined parameter.

36. The computer program product of claim 35, wherein the predetermined parameter is a programmed mobile parameter.

37. The computer program product of claim 35, wherein the predetermined parameter is based on a number of synchronization signals that a wireless node may simultaneously detect on a pilot channel.

38. The computer program product of claim 37, wherein the pilot channel is an uplink pilot channel (UpPCH).

39. The computer program product of claim 35, wherein the predetermined parameter is based on a number of uplink channels.

40. The computer program product of claim 39, wherein the uplink channel comprises a Physical Random Access Channel (PRACH).

41. The computer program product of claim 35, wherein the predetermined parameter is based on a transmission time interval (TTI).

42. The computer program product of claim 35, wherein the computer-readable medium further comprises code for transmitting a second synchronization signal.

43. The computer program product of claim 42, wherein the second synchronization signal is a retransmission of the synchronization signal.

44. The computer program product of claim 31, wherein the computer-readable medium further comprises code for:
detecting a transmission of a separate acknowledgment to another synchronization signal transmitted by another wireless node; and
transmitting a second synchronization signal upon determining that the other synchronization signal was transmitted after the transmission of the synchronization signal.

45. The computer program product of claim 31, wherein the acknowledgement comprises a reference to a synchronization signal position, the reference comprising a first portion indicating a timing reference and a second portion extending the timing reference.

46. An apparatus for wireless communication in a time division-synchronous code division multiple access (TD-SCDMA) system, comprising:
a processing system configured to:
transmit a first synchronization signal to request access to a Node B;
detect an acknowledgement transmitted from the Node B, wherein the acknowledgment comprises an indication that a second synchronization signal was transmitted after the first synchronization signal; and
retransmitting the first synchronization signal based on the acknowledgment.

47. The apparatus of claim 46, wherein the acknowledgment includes a predetermined number of bits.

48. The apparatus of claim 46, wherein the acknowledgment from the Node B is based on an order of receipt of transmission of the synchronization signal by the Node B.

49. The apparatus of claim 46, wherein the synchronization signal comprises a SYNC_UL signal.

50. The apparatus of claim 46, wherein the detection of the acknowledgement comprises detecting the acknowledgment for a period of time based on a predetermined parameter.

51. The apparatus of claim 50, wherein the predetermined parameter is a programmed mobile parameter.

52. The apparatus of claim 50, wherein the predetermined parameter is based on a number of synchronization signals that a wireless node may simultaneously detect on a pilot channel.

53. The apparatus of claim 52, wherein the pilot channel is an uplink pilot channel (UpPCH).

54. The apparatus of claim 50, wherein the predetermined parameter is based on a number of uplink channels.

55. The apparatus of claim 54, wherein the uplink channel comprises a Physical Random Access Channel (PRACH).

56. The apparatus of claim 50, wherein the predetermined parameter is based on a transmission time interval (TTI).

57. The apparatus of claim 50, further comprising transmitting a second synchronization signal.

58. The apparatus of claim 57, wherein the second synchronization signal is a retransmission of the synchronization signal.

59. The apparatus of claim 46, wherein the processing system is further configured to:
detect a transmission of a separate acknowledgment to another synchronization signal transmitted by another wireless node; and
transmit a second synchronization signal upon determining that the other synchronization signal was transmitted after the transmission of the synchronization signal.

60. The apparatus of claim 46, wherein the acknowledgement comprises a reference to a synchronization signal position, the reference comprising a first portion indicating a timing reference and a second portion extending the timing reference.
